(19) United States
(12) Patent Application Publication
(10) Pub. No.: US 2024/0385283 A1
(43) Pub. Date: Nov. 21, 2024

(54) RADAR SIGNAL GENERATOR ARRANGEMENT, RADAR ARRANGEMENT AND RADAR SYSTEM

(71) Applicant: HUAWEI TECHNOLOGIES CO., LTD., Shenzhen (CN)

(72) Inventors: Zhongxia Simon He, Munich (DE); Hossein Mashad Nemati, Munich (DE)

(21) Appl. No.: 18/786,406

(22) Filed: Jul. 26, 2024

Related U.S. Application Data
(63) Continuation of application No. PCT/EP2022/052040, filed on Jan. 28, 2022.

(51) Int. Cl. G01S 7/02; G01S 7/35; G01S 13/40; G01S 13/87; G01S 13/931

(52) U.S. Cl. CPC G01S 7/0235; G01S 7/0232; G01S 7/0233; G01S 7/35; G01S 13/40; G01S 13/87; G01S 13/931; G01S 2013/93271; G01S 2013/93272

(57) ABSTRACT

A radar signal generator arrangement includes a reference signal source configured to provide a reference signal, a plurality of radar signal generators, and a scheduler. Each radar signal generator is configured to generate a respective radar signal based on the reference signal for transmission via a millimeter-wave link. Each radar signal generator is configured to align a phase of the respective radar signal with a phase of the reference signal. The scheduler is configured to provide for each radar signal generator a respective scheduling signal which indicates a time-frequency characteristic for the respective radar signal. Each radar signal generator is configured to generate the respective radar signal having the time-frequency characteristic indicated by the respective scheduling signal.

### CROSS-REFERENCE TO RELATED APPLICATIONS

This application is a continuation of International Application No. PCT/EP2022/052040, filed on Jan. 28, 2022, the disclosure of which is hereby incorporated by reference in its entirety.

### FIELD

The present disclosure relates to the field of radar systems and automotive radar modules for millimeter wave signal transmission, for example in particular in automotive applications. The disclosure relates to a radar signal generator arrangement, a radar arrangement, a radar system, and corresponding methods. The present disclosure describes an automotive radar network with distributed radar units and a method for real-time reconfiguration of waveforms and adaptive simultaneous multi beams.

### BACKGROUND

Current automotive radars are independent modules with limited interaction between modules, enhancing radar imaging requires larger antenna area which implies larger radar modules. A trend is to establish connections between distributed radars; larger virtual antennas can be obtained therefore to gain higher imaging resolution. However, adapting several radar modules without phase synchronization and coordination may not result in best detection outcome as well as potential interference between radars may occur.

Limited by current radar hardware architecture, fully phase synchronized, interference free, simultaneous multiple beam and adaptive beam width cannot be achieved all together.

### SUMMARY

The present disclosure provides solutions to the problems described above and includes a novel radar hardware architecture.

In an embodiment, the novel radar hardware architecture uses several identical generic radar units (GRU), also referred to as radar arrangements hereinafter, and a centralized radar chirp generator (CRCG), also referred to as a radar signal generator arrangement as a more general term hereinafter. The identical GRUs can be of one or few types. A single GRU may be preferred but there can be more than one. The CRCG can be physically within or outside one of the radar modules.

The GRUs and the CRCG are connected with several mmW (millimeter wave) links. The connection can feed signals of same frequency as radar transmission waveform. The mmW link can be an optical link, a flexible waveguide, or a wireless link, for example.

Each GRU contains several antennas, each antenna can be assigned with one waveform from CRCG, therefore these antennas can be groups for virtual antenna array. The GRU can perform phase modulation (PM) for each antenna for increasing virtual array diversity.

The present disclosure describes several advantages over conventional methods in the field of radar systems and automotive radar modules including simultaneous multiple beams utilizing antennas in one module or in several modules; adaptive beam adjustment, by using different number of antennas; improved MIMO resolution due to enhanced antenna aperture; and reduced self and extrinsic interference by the centralized coordination.

The following abbreviations and terms are used in this disclosure:
WG: waveguide
mmW: millimeter wave or millimeter wave (signal)
TL: transmission line
TEM: Transverse electromagnetic mode
TE: Transverse electric mode
PCB: Printed Circuit Board
GRU: generic radar unit, also referred to as radar arrangement hereinafter
CRCG: centralized radar chirp generator, also referred to as radar signal generator arrangement hereinafter
MIMO: multiple input multiple output

According to a first aspect, the present disclosure provides a radar signal generator arrangement for generating a plurality of radar signals, the radar signal generator arrangement comprising: a reference signal source configured to provide a reference signal; a plurality of radar signal generators, each radar signal generator being configured to generate a respective radar signal based on the reference signal for transmission via a millimeter-wave link, wherein each radar signal generator is configured to align a phase of the respective radar signal with a phase of the reference signal; and a scheduler configured to provide for each of the plurality of radar signal generators a respective scheduling signal, the scheduling signal indicating a time-frequency characteristic for the respective radar signal; wherein each radar signal generator is further configured to generate the respective radar signal having the time-frequency characteristic indicated by the respective scheduling signal while all radar signals generated are phase coherently.

Such a radar signal generator arrangement provides a novel hardware architecture for providing a plurality of coordinated and phase-synchronized radar signals resulting in improved radar detection results and reduced interference between the radar signals. The radar signal generator arrangement provides an advantageous solution for fully phase synchronized, interference free, simultaneous multiple beam and adaptive beam width radar signals.

The scheduler can provide a respective scheduling signal for each radar signal generator. Any number of radar signal generators and corresponding number of scheduling signals can be applied by such radar signal generator arrangement. The signal generator configuration and the timing of enabling new configuration will be transferred to GRUs, therefore GRUs are synchronized when new configuration is enabled.

In an exemplary implementation form of the radar signal generator arrangement, each radar signal generator comprises a voltage-controlled oscillator or digital numerical controlled oscillator and a phase locked loop controller for controlling the voltage-controlled oscillator or digital numerical controlled oscillator; wherein the scheduler is configured to provide each phase locked loop controller with a respective frequency control signal for controlling oscillators to generate the radar signals having the time-frequency characteristic indicated by the respective scheduling signal.

Such a radar signal generator arrangement provides the advantage of a fully phase-synchronized solution. The radar signals are phase-synchronized and can yet have different time-frequency characteristics to generate a plurality of different radar beams according to specific requirements.

In an exemplary implementation form of the radar signal generator arrangement, each radar signal comprises a respective millimeter wave chirp signal.

Such a chirp signal is a signal in which the frequency increases or decreases periodically with time. It can be advantageously applied to radar systems. This signal type occurs as a phenomenon due to dispersion, a non-linear dependence between frequency and the propagation speed of the wave components. Depending on the echo signal, the characteristics of the channel can be estimated.

In an exemplary implementation form of the radar signal generator arrangement, the time-frequency characteristic is different for any two of the radar signals.

This provides the advantage that different coordinated phase-aligned beams of different beam characteristics can be provided for different visualization of the vehicle environment.

In an exemplary implementation form of the radar signal generator arrangement, the scheduler is configured to provide information about the time-frequency and phase characteristic and the enable timing of the respective radar signals for transmission over the millimeter-wave link.

This provides the advantage that the radar signal generator arrangement can transmit the information about the time-frequency characteristics and the timing of signal changing via the millimeter-wave link to different radar arrangement that use these radar signals for radar processing. Hence, radar signal processing can be improved when information about the time-frequency characteristics of the radar signals is available.

In an exemplary implementation form of the radar signal generator arrangement, the scheduler is configured to transmit configuration information and trigger information over the millimeter-wave link, the configuration information enabling a radar arrangement to perform radar topology configuration based on the radar signals provided by the radar signal generator arrangement, and wherein the radar topology configuration is enabled at certain timing based on the trigger information.

This provides the advantage that configuration information and trigger information is available for radar signal processing, thereby improving the accuracy of the radar signal processing.

In an exemplary implementation form of the radar signal generator arrangement, a frequency of the reference signal is at least one order of magnitude smaller than a frequency of a respective radar signal.

This provides the advantage that the reference signal source can be easily implemented since no high frequency signal requirements have to be fulfilled.

According to a second aspect, the present disclosure provides a radar arrangement for performing radar signal processing, the radar arrangement comprising: a first radar transceiver of a plurality of radar transceivers locate in a GRU or several GRUs, the first radar transceiver being configured to transmit a first transmit radar signal and/or to receive a first receive radar signal; a second radar transceiver of the plurality of radar transceivers, the second radar transceiver being configured to transmit a second transmit radar signal and/or to receive a second receive radar signal; and a switch box configured to receive a plurality of phase-aligned radar signals via a millimeter-wave link, each radar signal having a corresponding time-frequency characteristic, wherein the switch box is configured, based on a switching scheme, to switch a first radar signal of the plurality of phase-aligned radar signals to the first radar transceiver for transmission as the first transmit radar signal and to switch a second radar signal of the plurality of phase-aligned radar signals to the second radar transceiver for transmission as the second transmit radar signal.

Each radar or GRU has several transceiver channels, each channel corresponding to several antennas. Several antennas in the first radar (GRU) can use radar signal 1 and/or simultaneously radar signal 2. That means, there can be multiple signals in a GRU.

Such a radar arrangement provides a novel hardware architecture for radar processing a plurality of coordinated and phase-synchronized radar signals resulting in improved radar detection results and reduced interference between the radar signals. The radar arrangements can receive fully phase synchronized, interference free, simultaneous multiple beam and adaptive beam width radar signals resulting in improved radar signal processing.

In an exemplary implementation form of the radar arrangement, the switch box is configured to arbitrarily switch any of the phase-aligned radar signals to any of the plurality of radar transceivers within corresponding GRUs.

This provides the advantage of high flexibility for choosing the radar signals for radar signal processing. Different radar beams can be implemented around the vehicle depending on different road conditions.

In an exemplary implementation form of the radar arrangement, the time-frequency characteristic is different for any two of the radar signals.

This provides the advantage that different coordinated phase-aligned beams of different beam characteristics can be used for different visualization of the vehicle environment.

In an exemplary implementation form of the radar arrangement, the radar arrangement is configured to receive information about the time-frequency characteristic of the respective radar signals via the millimeter-wave link.

This provides the advantage that the radar arrangement can receive the information about the time-frequency characteristics via the millimeter-wave link in coordination with other GRUs (radar arrangements) providing radar processing. Hence, a coordinated radar signal processing can be provided across multiple GRUs resulting in improved accuracy.

In an exemplary implementation form of the radar arrangement, the radar arrangement is configured to receive configuration information via the millimeter-wave link, the configuration information enabling a configuration of the first radar transceiver and the second radar transceiver.

This provides the advantage that configuration information can be easily provided via the millimeter-wave link, thereby improving the accuracy and joint coordination of the radar signal processing of multiple GRUs (radar arrangements).

In an exemplary implementation form of the radar arrangement, the radar arrangement is configured to transfer first echo data based on the first receive radar signal to a master processor; and/or configured to transfer second echo data based on the second receive radar signal to the master processor. Echo waveforms received by all transceiver channels may be transferred to a centralized processor (herein called the “master processor”) for joint processing.

Note that transferring as described above may define some internal transfer in contrast to an external transmission.

This provides the advantage that the first echo data and/or the second echo data can be advantageously applied by the master processor to evaluate the radar processing and to visualize the environment.

In an exemplary implementation form of the radar arrangement, the radar arrangement is configured to enable the first radar transceiver to receive a first receive radar signal that is based on a transmit radar signal from at least one other radar transceiver of the plurality of radar transceivers.

This provides the advantage of coordinated radar signal processing. Due to the phase-synchronicity of the radar signals, echo signals from other transceivers can be received as well, which can be used for a better visualization of the environment.

The first radar transceiver can transmit the first transmit radar signal and receive the first receive radar signal as a response to the first transmit radar signal. However, the first radar transceiver can also receive radar signals in response to transmit radar signals of other radar transceivers. This results in a flexible configuration.

According to a third aspect, the present disclosure provides a radar system useable for automotive applications, the radar system comprising: a radar signal generator arrangement described above; and at least one radar arrangement described above coupled to the radar signal generator arrangement via a millimeter-wave link.

Such a radar system provides a novel hardware architecture for providing a plurality of coordinated and phase-synchronized radar beams resulting in improved radar detection results and reduced interference between the radar signals. The radar system provides an advantageous solution for fully phase synchronized, interference free, simultaneous multiple beam and adaptive beam width radar signals.

In an exemplary implementation form of the radar system, the millimeter-wave link comprises a plurality of millimeter-wave links for transmission of the plurality of radar signals.

This provides the advantage that the millimeter-wave link can be flexibly applied for forwarding multiple radar signals to different transceivers in different GRUs (radar arrangements) located at different positions in the vehicle.

In an exemplary implementation form of the radar system, the plurality of millimeter-wave links comprises at least one of an optical link, a flexible waveguide, or a wireless link.

This provides the advantage that the millimeter-wave links can be flexibly implemented by different types of links.

In an exemplary implementation form of the radar system, the radar system is configured to process one or more antenna beams, wherein each antenna beam is based on one or more transmit and/or receive radar signals of the plurality of radar transceivers of the at least one radar arrangement.

This provides the advantage that different antenna beams can be applied to improve the resolution of the radar signal processing.

In an exemplary implementation form of the radar system, the radar system is configured to process multiple antenna beams simultaneously, wherein each antenna beam is based on at least one different transmit and/or receive radar signal.

This provides the advantage of high resolution and accuracy of the radar signal processing.

In an exemplary implementation form of the radar system, the radar system is configured to adjust a beam width of an antenna beam by assigning specific transmit and/or receive radar signals of the plurality of radar transceivers to the antenna beam.

This provides the advantage of flexible radar signal processing with high precision.

In an exemplary implementation form of the radar system, the radar system is configured to adjust the beam width of the antenna beam by assigning specific transmit and/or receive radar signals of radar transceivers which are located at different radar arrangements to the antenna beam.

This provides the advantage that multiple radar arrangements can be simultaneously implemented which may be located at different places thereby improving detection results of the radar signal processing.

According to a fourth aspect, the present disclosure provides a method for generating a plurality of radar signals, the method comprising: providing a reference signal by a reference signal source; generating a respective radar signal, by a plurality of radar signal generators, based on the reference signal for transmission via a millimeter-wave link, wherein a phase of the respective radar signal is aligned with a phase of the reference signal; providing, by a scheduler, for each of the plurality of radar signal generators a respective scheduling signal, the scheduling signal indicating a time-frequency characteristic for the respective radar signal; and generating, by each radar signal generator, the respective radar signal having the time-frequency characteristic indicated by the respective scheduling signal. Upon changing radar signal at different slot, the mmW link also controls the switch to distribute signal to correct transceivers at different GRUs at correct timing.

Such a method provides the same advantages as the radar signal generator arrangement according to the first aspect, i.e., it provides a novel method for providing a plurality of coordinated and phase-synchronized radar signals resulting in improved radar detection results and reduced interference between the radar signals. The method provides an advantageous solution for fully phase synchronized, interference free, simultaneous multiple beam and adaptive beam width radar signal processing.

According to a fifth aspect, the present disclosure provides a method for performing radar signal processing, the method comprising: transmitting, by a first radar transceiver of a plurality of radar transceivers, a first transmit radar signal and/or receiving, by the first radar transceiver, a first receive radar signal; transmitting, by a second radar transceiver of the plurality of radar transceivers, a second transmit radar signal and/or receiving, by the second radar transceiver, a second receive radar signal; receiving, by a switch box, plurality of phase-aligned radar signals via a millimeter-wave link, each radar signal having a corresponding time-frequency characteristic; and switching, by the switch box, based on a switching scheme, a first radar signal of the plurality of phase-aligned radar signals to the first radar transceiver for transmission as the first transmit radar signal and switching, by the switch box, a second radar signal of the plurality of phase-aligned radar signals to the second radar transceiver for transmission as the second transmit radar signal.

Such a method provides the same advantages as the radar arrangement according to the second aspect, i.e., it provides a novel method for radar processing a plurality of coordinated and phase-synchronized radar signals resulting in improved radar detection results and reduced interference between the radar signals. The method implements fully phase synchronized, interference free, simultaneous multiple beam and adaptive beam width radar signal processing.

According to a sixth aspect, the present disclosure provides a computer program product including computer executable code or computer executable instructions that, when executed, causes at least one computer to execute the method according to the fourth aspect or the fifth aspect described above.

Such a computer program product can be implemented for example on a computer, a processor or a controller.

### BRIEF DESCRIPTION OF THE DRAWINGS

Further embodiments of the disclosure will be described with respect to the following figures, in which:

FIG. 1 shows a block diagram illustrating a radar signal generator arrangement 100 according to the present disclosure;

FIG. 2 shows a block diagram illustrating a radar system 200 with radar signal generator arrangement 100 and radar arrangement 200 according to the present disclosure;

FIG. 3 shows a schematic diagram illustrating a switch box 210 for switching radar signals according to the present disclosure;

FIG. 4 shows a schematic diagram illustrating a radar system 400 according to the present disclosure implemented in a vehicle;

FIG. 5 shows a schematic diagram illustrating an adaptive beam example 500 for the radar system 400 shown in FIG. 4;

FIG. 6 shows a schematic diagram illustrating a multiple beam example 600 for the radar system 400 shown in FIG. 4;

FIG. 7 shows a schematic diagram illustrating a virtual array example 700 for the radar system 400 shown in FIG. 4;

FIG. 8 shows a schematic diagram illustrating a method 800 for generating a plurality of radar signals according to the present disclosure; and

FIG. 9 shows a schematic diagram illustrating a method 900 for performing radar signal processing according to the present disclosure.

### DETAILED DESCRIPTION

In the following detailed description, reference is made to the accompanying drawings, which form a part thereof, and in which is shown by way of illustration specific aspects in which the present disclosure may be practiced. It is understood that other aspects may be utilized and structural or logical changes may be made without departing from the scope of the present disclosure. The following detailed description, therefore, is not to be taken in a limiting sense.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

In this disclosure, millimeter waves and millimeter wave links are described. Millimeter waves are a form of electromagnetic radiation with wavelengths ranging from about one meter to one millimeter corresponding to frequencies between about 300 MHz and 300 GHz respectively. Millimeter wave links are transmission channels for millimeter waves. Millimeter wave links may be implemented in hardware, e.g., by waveguides that may be realized by fiber or flexible waveguides. Several radar signals may be transmitted over one millimeter wave link.

Millimeter wave signals as described in this disclosure can be radar waves and radar wave signals or simply radar signals in a frequency range between about 40 GHz and 100 GHz corresponding to wavelengths between about 0.75 cm and 0.30 cm.

In the present disclosure waveguides, in particular waveguides for microwave transmission are described. A waveguide is a transmission line for radio waves. A waveguide for microwave transmission is a transmission line for microwaves. The waveguide can be formed as a hollow metal pipe and can be used for such purposes as connecting microwave transmitters and receivers to their antennas.

In the present disclosure, radar modules are described. Current vehicles may have multiple radar modules for long range (LR), short range (SR), corners, etc. The front mid-range and long-range radars are very different from the short-range corner radars in terms of capabilities and FoV (field of view). The different modules need extensive validation and verification before they can be qualified for road application. The verification often requires extensive testing that could be about 3600 km of driving (5 cars during 90 days for 8 hours a day or the equivalent).

The overall product volume of automotive radar modules may include different module types. There is an industry trend to have more side sensors than front and back, even 6 SRR (short range radars) and 2 MRR (medium range radars). As SRRs tend to be short range, there may be specialization in the functions of MRR and LR versus SRRs. Emerging functions such as LCA (lane change assistant) may require mid-range in the rear range which is not possible currently with existing corner radars. There may also be a push to split SRRs into two versions: a long-range version (to compete with MRR) that may be used as a front sensor as well (hence eliminating MRRs) and a short version (inside 20 m) with a large vertical aperture for Az (azimuth) and EL (elevation) measurements.

The current trend of using an mmW radar is that several radars can be synchronized or fused for improving detection resolution. Current production radars can be synchronized with CAN AUTOSAR and time stamps, but these methods cannot fulfil the timing accuracy for advanced radar fusion, beamforming, or reduce the diversity of radar module types. New phase synchronization methods can improve multi-radar performance.

In the present disclosure, flexible waveguides are described. Such a flexible waveguide can be used to guide radio frequency signals. Such flexible waveguide comprises an elongate flexible tubing having an elongate shape. The elongate flexible tubing comprises an inner surface defining an elongate airtight cavity. The elongate airtight cavity extends from a first end of the elongate flexible tubing to a second end of the elongate flexible tubing. The first end is configured to couple the radio frequency signal into and/or out of the elongate airtight cavity. The inner surface can guide the radio frequency signal along the waveguide device. The second end is configured to couple the radio frequency signal out of and/or into the elongate airtight cavity. When the elongate airtight cavity is filled with a pressurized gaseous fluid, the elongate flexible tubing is configured to retain its elongate shape.

The inner surface of the elongate flexible tubing can be a metallized inner surface, for example. The inner surface can have a circular, rectangular, H-shaped or C-shaped cross section, for example. The elongate flexible tubing may further comprise an outer isolation layer and a semi-rigid isolation material arranged between the outer isolation layer and the inner surface. The flexible waveguide may further comprise one or more metallic conducting lines which can be embedded within the elongate flexible tubing and may extend along the flexible waveguide. The one or more metallic conducting lines can be embedded within an outer isolation layer of the elongate flexible tubing. These metallic conducting lines may be configured to transmit one or more control signals and/or power signals from the first end to the second end of the elongate flexible tubing. For example, the elongate flexible tubing may comprise an openable pressurization hole connected to the airtight elongate cavity. The airtight elongate cavity may be configured to receive the pressurized fluid, when the openable pressurization hole is opened. The flexible waveguide may comprise a flange at the first end and/or the second end of the elongate flexible tubing. The flange may be sealed by a scaling gasket. The flexible waveguide may comprise a waveguide-to-coax interface at the first end and/or the second end. The flexible waveguide may further comprise an interface printed circuit board (PCB) at the first end and/or the second end of the elongate flexible tubing. The interface PCB may be soldered to a further PCB of a transmitter or receiver.

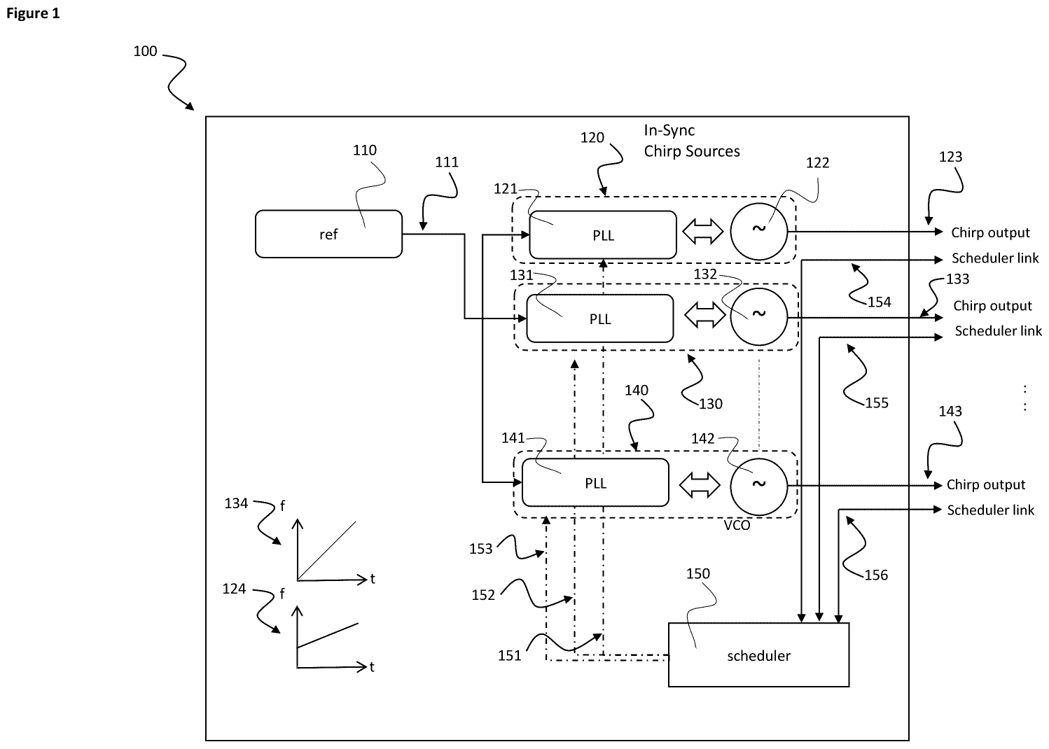

FIG. 1 shows a block diagram illustrating a radar signal generator arrangement 100 according to the present disclosure.

The radar signal generator arrangement 100 can be used for generating a plurality of radar signals 123, 133, 143. The radar signal generator arrangement 100 comprises a reference signal source 110 configured to provide a reference signal 111; a plurality of radar signal generators 120, 130, 140; and a scheduler 150.

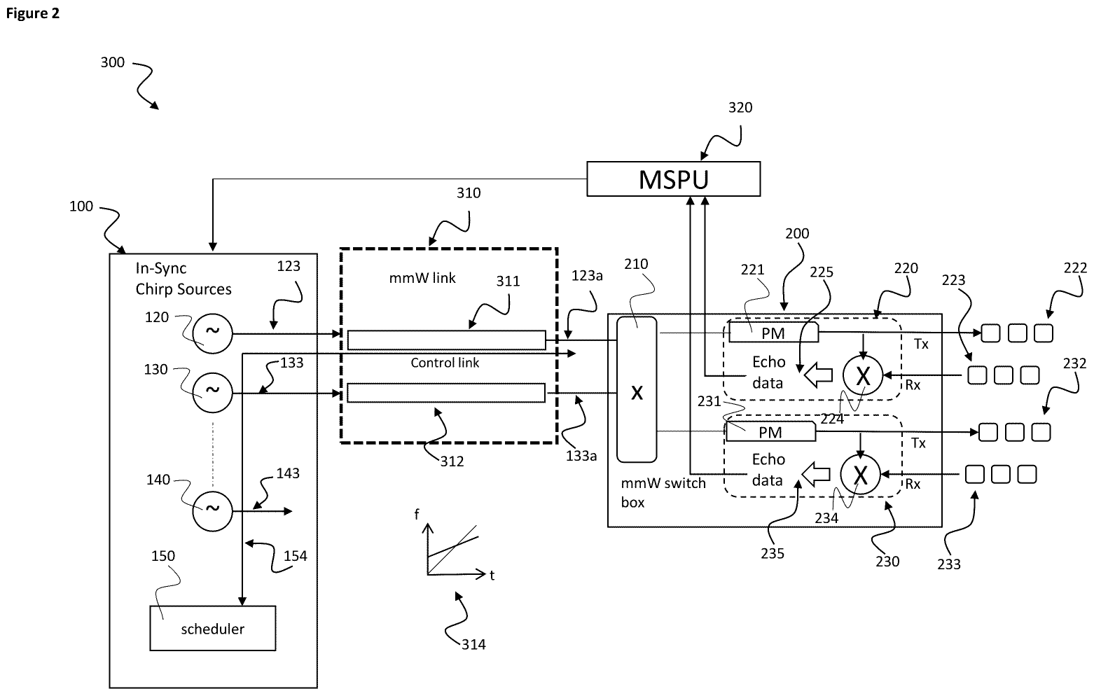

Each radar signal generator 120, 130, 140 is configured to generate a respective radar signal 123, 133, 143 based on the reference signal 111 for transmission via a millimeter-wave link 310 as shown in FIG. 2 for example.

Each radar signal generator 120, 130, 140 is configured to align a phase of the respective radar signal 123, 133, 143 with a phase of the reference signal 111.

The scheduler 150 is configured to provide for each of the plurality of radar signal generators 120, 130, 140 a respective scheduling signal 151, 152, 153. The scheduling signal 151, 152, 153 indicates a time-frequency characteristic 124, 134 for the respective radar signal 123, 133, 143.

Each radar signal generator 120, 130, 140 is further configured to generate the respective radar signal 123, 133, 143 having the time-frequency characteristic 124, 134 indicated by the respective scheduling signal 151, 152, 153.

Note that the scheduler 150 can provide a respective scheduling signal 151, 152, 153 for each radar signal generator 120, 130, 140. While the figure shows only an exemplary number of three radar signal generators 120, 130, 140, any other number of radar signal generators and corresponding number of scheduling signals can be applied as well.

Each radar signal generator 120, 130, 140 may comprise a voltage-controlled oscillator or digital numerical controlled oscillator 122, 132, 142 and a phase locked loop controller 121, 131, 141 for controlling the voltage-controlled oscillator 122, 132, 142.

The scheduler 150 is configured to provide each phase locked loop controller 121, 131, 141 with a respective frequency control signal 151, 152, 153 for controlling the oscillator 122, 132, 142 to generate the radar signal 123, 133, 143 having the time-frequency characteristic 124, 134 indicated by the respective scheduling signal 151, 152, 153.

The time-frequency characteristic 124, 134 may be a straight line having a positive or negative gradient over time, e.g., as shown in FIG. 1 in order to generate a chirp signal, for example. In embodiments, the time-frequency characteristic 124, 134 may have any other shape defining any time-variant frequency.

Each radar signal 123, 133, 143 may comprise a respective millimeter wave chirp signal that may be specified by the respective time-frequency characteristic 124, 134.

The time-frequency characteristic 124, 134 may be different for any two of the radar signals 123, 133, 143.

The scheduler 150 may be configured to provide information about the time-frequency characteristic 124, 134 of the respective radar signals 123, 133, 143 for transmission over the millimeter-wave link 310, e.g., as shown in FIG. 2.

The scheduler 150 may be configured to transmit configuration information and trigger information over the millimeter-wave link 310. The configuration information enables a radar arrangement 200, e.g., as shown in FIG. 2, to perform radar topology configuration based on the radar signals 123, 133, 143 provided by the radar signal generator arrangement 100. The radar topology configuration can be enabled at certain timing based on the trigger information.

A frequency of the reference signal 111 can be at least one order of magnitude smaller than a frequency of a respective radar signal 123, 133, 143.

In an exemplary implementation, the radar signal generator arrangement 100 is configured to generate chirp signals as radar signals. In this implementation, the radar signal generator arrangement 100 is also referred to as centralized radar chirp generator (CRGC). The CRGC contains several voltage-controlled oscillators (VCO) 122, 132, 142 which can generate mmW chirp signals as one example of radar signals 123, 133. The PLL controller 121, 131, 141 may contain a frequency phase detector and a frequency divider. Based on the scheduler input 151, 152, 153, the PLL controller 121, 131, 141 can generate voltage control for VCO 122, 132, 142 and ensure that VCO phase is aligned with the reference signal 111. The CRCG 100 can output several chirp output signals 123, 133 and several scheduler commands 154, 155 to GRU 200 as shown in FIG. 2. The Scheduler 150 enables central control for all GRUs 200 down to individual antenna waveform level.

FIG. 2 shows a block diagram illustrating a radar system 200 with radar signal generator arrangement 100 and radar arrangement 200 according to the present disclosure.

The radar signal generator arrangement 100 corresponds to the radar signal generator arrangement 100 described above with respect to FIG. 1.

The radar arrangement 200 may be used for performing radar signal processing.

The radar arrangement 200 comprises: a first radar transceiver 220 of a plurality of radar transceivers; a second radar transceiver 230 of the plurality of radar transceivers; and a switch box 210. It should be understood that more than the two shown radar transceivers 220, 230 can be implemented as well.

The first radar transceiver 220 is configured to transmit a first transmit radar signal 222 and/or to receive a first receive radar signal 223.

The second radar transceiver 230 is configured to transmit a second transmit radar signal 232 and/or to receive a second receive radar signal 233.

The switch box 210 is configured to receive a plurality of phase-aligned radar signals 123, 133, 143 via a millimeter-wave link 310. Each radar signal 123, 133, 143 has a corresponding time-frequency characteristic 124, 134, e.g. as described above with respect to FIG. 1.

The switch box 210 is configured, based on a switching scheme, to switch a first radar signal 123 of the plurality of phase-aligned radar signals 123, 133, 143 to the first radar transceiver 220 for transmission as the first transmit radar signal 222 and to switch a second radar signal 133 of the plurality of phase-aligned radar signals 123, 133, 143 to the second radar transceiver 230 for transmission as the second transmit radar signal 232.

Note that any other switching can be implemented as well. For example, the second radar signal 133 can be switched to the first radar transceiver 220 and the first radar signal 123 can be switched to the second radar transceiver 230. Or, the first radar signal 123 and the second radar signal 133 can be switched to the first radar transceiver 220 or to the second radar transceiver 230. Or, the first radar signal 123 and the second radar signal 133 can be switched to the first radar transceiver 220 and a third radar signal 143 can be switched to the second radar transceiver 230, etc.

The switch box 210 may be configured to arbitrarily switch any of the phase-aligned radar signals 123, 133, 143 to any of the plurality of radar transceivers. This means that any switching scheme can be used for implementing the arbitrary switching.

The phase-aligned radar signals 123, 133, 143 switched by the switch box 210 are then phase code modulated in a respective phase code modulator 221, 231. The phase code modulator 221, 231 can periodically change output phase of the radar signal and may be controlled by the scheduler 150.

The time-frequency characteristic 124, 134 may be different for any two of the radar signals 123, 133, 143.

The radar arrangement 200 can be configured to receive information about the time-frequency characteristic 124, 134 of the respective radar signals 123, 133, 143 via the millimeter-wave link 310, e.g., scheduler link information 154 via a control link 311 of the mmW link 310 from the scheduler 150.

The radar arrangement 200 may be configured to receive configuration information via the millimeter-wave link 310. This configuration information can enable a configuration of the first radar transceiver 220 and/or the second radar transceiver 230. The configuration information may be received via the control link 311 of the mmW link 310 from the scheduler 150.

The radar arrangement 200 may be configured to transmit first echo data 225 based on the first receive radar signal 223 to a master processor 320. The radar arrangement 200 may be configured to transmit second echo data 235 based on the second receive radar signal 233 to the master processor 320. The master processor 320 may be coupled with the radar signal generator arrangement 100 to provide this echo data or information thereof to the radar signal generator arrangement 100.

The radar arrangement 200 may be configured to enable the first radar transceiver 220 to receive the first receive radar signal 223 that is based on a transmit radar signal from at least one other radar transceiver of the plurality of radar transceivers.

For example, the first radar transceiver 220 can transmit the first transmit radar signal and receive the first receive radar signal as a response to the first transmit radar signal. However, the first radar transceiver 220 can also receive radar signals in response to transmit radar signals of other radar transceivers. This results in a flexible configuration.

The radar system 300 shown in FIG. 2 can be used for automotive applications, for example. Such radar system 300 comprises a radar signal generator arrangement 100 as described above with respect to FIG. 1; and at least one radar arrangement 200 as described above that is coupled to the radar signal generator arrangement 100 via a millimeter-wave link 310 as shown in FIG. 2.

The millimeter-wave link 310 may comprise a plurality of millimeter-wave links 311, 312 for transmission of the plurality of radar signals 123, 133, 143 or for transmission of control signals via a control link.

The plurality of millimeter-wave links 311, 312 may comprise at least one of an optical link, a flexible waveguide, or a wireless link.

The radar system 300 may be configured to process one or more antenna beams, wherein each antenna beam may be based on one or more transmit and/or receive radar signals of the plurality of radar transceivers of the at least one radar arrangement 200.

The radar system 300 may be configured to process multiple antenna beams simultaneously. Each antenna beam can be based on at least one different transmit and/or receive radar signal.

The radar system 300 may be configured to adjust a beam width of an antenna beam by assigning specific transmit and/or receive radar signals of the plurality of radar transceivers to the antenna beam.

The radar system 300 may be configured to adjust the beam width of the antenna beam by assigning specific transmit and/or receive radar signals of radar transceivers which are located at different radar arrangements 200 to the antenna beam.

In an exemplary implementation, the radar signal generator arrangement 100 is configured to generate chirp signals as radar signals and the radar arrangement 200 is configured to receive chirp signals as radar signals. In this implementation, the radar signal generator arrangement 100 is also referred to as centralized radar chirp generator (CRGC) and the radar arrangements 200 are also referred to as generic radar units (GRUs).

The CRCG 100 may contain one or more In-Sync chirp Sources 120, 130, 140. At least two, preferable six chirp sources 120, 130, 140 can be build-in. The number of the chirp sources 120, 130, 140 may correspond to a number of maximum simultaneous existing beams around the car. All chirps are phase synchronized by using the same reference signal 111 (see FIG. 1) at lower frequency, but each of the chirp sources 120, 130, 140 can sweep its frequency over time independently which is controlled by the scheduler 150, e.g., as described above with respect to FIG. 1.

Several generic radar units (GRU) 200 are connected to the CRCG 100 by a special mmW link 310. The mmW link 310 can be realized by fiber, flexible waveguide, etc. Several chirp signals 123, 133 can be transmitted over one mmW link 310.

On the GRU side 200, a mm-wave switch box 210 (commanded by the control link 311 over mmW link 310) can be used to connect different radar transceivers 220, 230 to one of defined chirp signals 123a, 123b from the mmW link 310. Each GRU 200 contains several TRX channels 222, 223, 232, 233 where individual phase modulation (PM) can be added, but only within chirp frequencies defined by mmW link 310. The chirp frequency is defined by the CRCG 100 and transferred to GRU 200 via the mmW link 310. Sampled echo data 225, 235 can be transferred back to a centralized processor 320 for signal processing. For this purpose, an Ethernet or any other bus in the car can be used, for example.

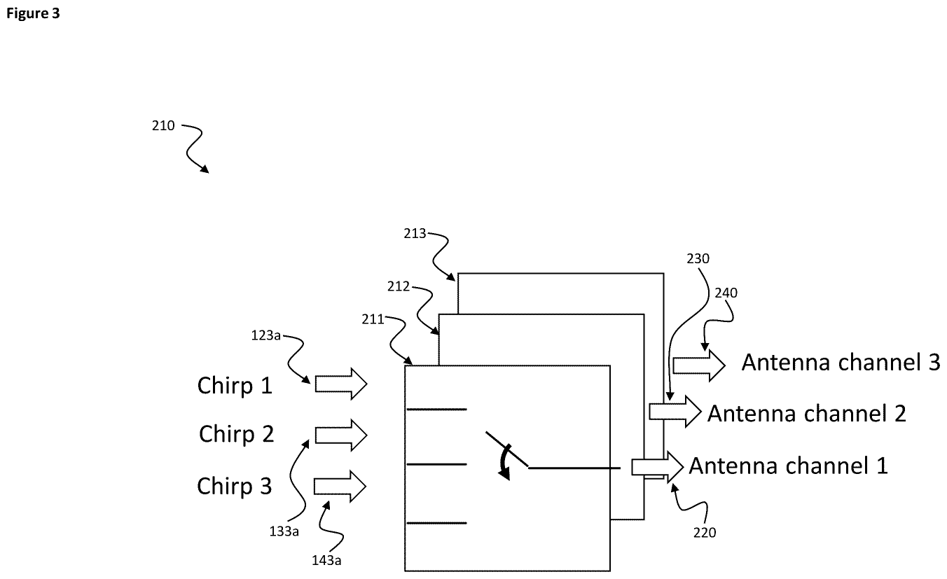

FIG. 3 shows a schematic diagram illustrating a switch box 210 for switching radar signals according to the present disclosure.

The switch box 210 corresponds to the switch box 210 described above with respect to FIG. 2. Several radar signals 123a, 133a, 143a are inputs to the switch box 210, e.g., a chirp 1, chirp 2 and chirp 3 signal. Each antenna channel 220, 230, 240 is connected to the switch box 210 which can feed any of the inputs 123a, 133a, 143a, e.g., chirp 1, chirp 2 and chirp 3 signal to the antenna channel 220, 230, 240. In this configuration each antenna can be freely connected to any input, e.g., chirp input. The switch box 210 connection can be controlled centrally by the scheduler 150 as shown in FIG. 1.

For the mmW link 310 as shown in FIG. 2, several implementation options are available, including multiple core fiber optic, wavelength division multiplex fiber, dielectric waveguide bundle, or flexible waveguide bundle.

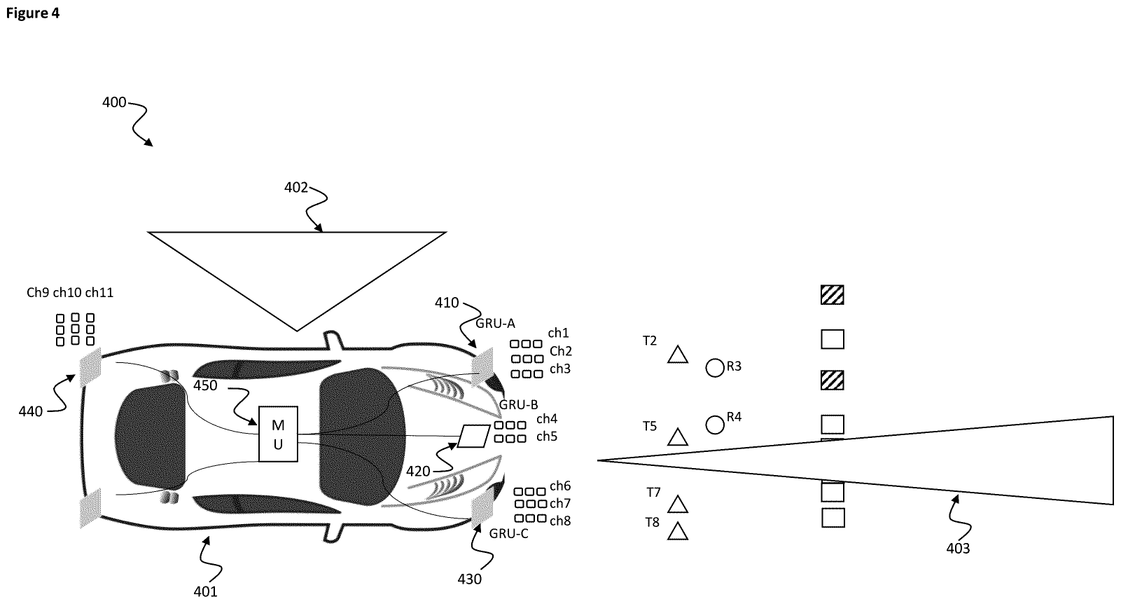

FIG. 4 shows a schematic diagram illustrating a radar system 400 according to the present disclosure implemented in a vehicle.

The radar system or radar network presented in this disclosure can be used to generate multiple beams simultaneously and/or adjust beam width by utilizing different antenna channels as shown in FIG. 4.

In this example of FIG. 4, the radar system 300 described above with respect to FIGS. 1 to 3 can be implemented in a vehicle 401. Multiple beams 402, 403 can be generated simultaneously and a beam width of these beams 402, 403 can be adjusted by using different antenna channels.

A front beam 403 can be produced with a smaller beam width than a beam width of a side beam 402, for example.

Multiple radar arrangements (GRUs) 200 as described above with respect to FIGS. 1 to 3 can be placed in the vehicle. For example, a first radar arrangement (GRU-A) 410 processes channels 1, 2 and 3, a first second arrangement (GRU-B) 420 processes channels 4 and 5, a third radar arrangement (GRU-C) 430 processes channels 6, 7 and 8, and a fourth radar arrangement 440 processes channels 9, 10 and 11. All radar arrangements 410, 420, 430, 440 are controlled by a master unit (MU) 450 that may be placed at a central position in the car.

The front beam 403 with small beam width may be processed by T2 (transmitter of channel 2), R3 (receiver of channel 3), T5 (transmitter of channel 5), R4 (receiver of channel 4), T7 (transmitter of channel 7) and T8 (transmitter of channel 8).

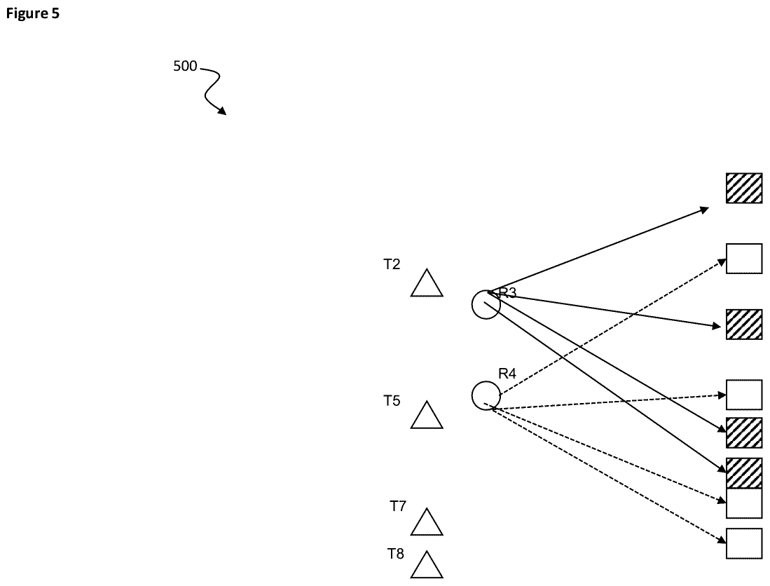

This radar system 400 can generate multiple beams simultaneously and/or adjust beam width by utilizing different antenna channels. Examples for this functionality are described below with respect to FIGS. 5, 6 and 7.

FIG. 5 shows a schematic diagram illustrating an adaptive beam example 500 for the radar system 400 shown in FIG. 4.

In this example, channels 2-5 and channels 7-8 are used for forward looking beam 403 as shown in FIG. 4. Each channel can either use Tx or Rx (or both). For instance, channels 2-3, channel 5 and channels 7-8 can be used as transmitter channels, while channel 3 and channel 4 can be used as receiver channels, where transmitter channels can be disabled.

When Tx channels are coded with different code (assigned by control link 311 as shown in FIG. 2), its echo can be processed and individually combined, and a denser virtual array can be achieved.

The beam radiation pattern can be changed by using different antennas that locate in different GRU modules. As illustrated in FIG. 5, by using different Tx and Rx combinations, a virtual aperture can be established for different beam widths and different radiation angles. By utilizing different antennas and configuring them as transmitter and/or receiver, the virtual aperture can be adjusted in real time.

Together with the beam 403 mentioned above with respect to FIG. 4, the non-occupied channels, namely, channel 1 and channels 9-11 can be used simultaneously for processing another side looking beam 402 as shown in FIG. 4. This beam 402 can also be adjustable by configuring these channels as transmitter and/or receiver at different time slots.

More importantly, this side beam 402 can use another radar signal or chirp configuration to avoid interference with the main beam 403 which is a novel feature that cannot be done with currently available distributed radar network architectures.

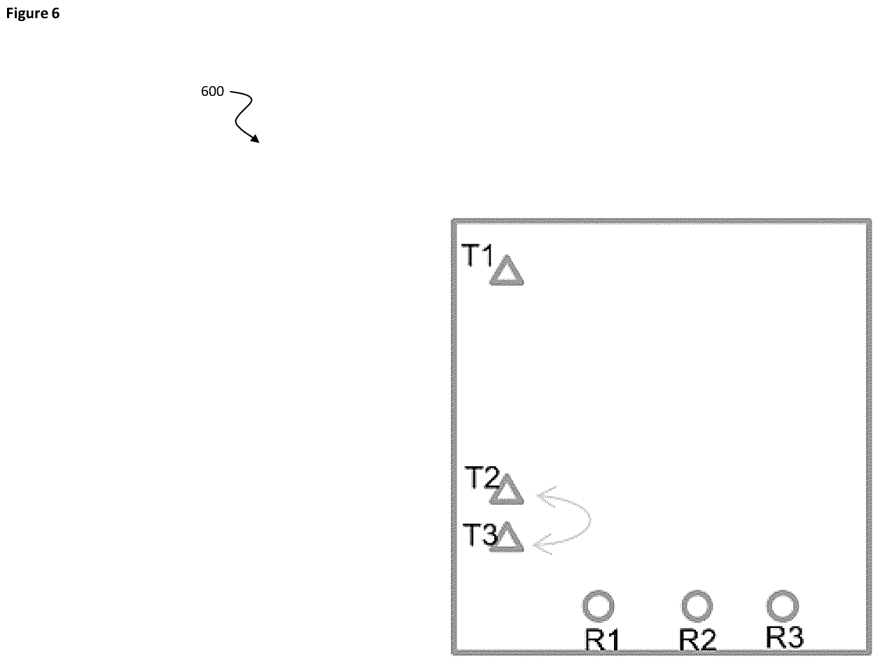

FIG. 6 shows a schematic diagram illustrating a multiple beam example 600 for the radar system 400 shown in FIG. 4.

By using one or several GRUs 200 as imaging radar, the radar system 400 can prevent antenna coupling and provide enhanced performance. For an imaging radar, the transmitter antenna and receiver may be placed at different locations, either at the same module (i.e., radar arrangement 200) or at different modules.

Some transmitter antennas may be closely placed, for example T2 and T3 as can be seen in FIG. 6, where mutual coupling between T2 and T3 may become a problem.

Traditionally, antennas are only separated with different phase codes, but due to this coupling, the interference reduces the code orthogonality which results in a poor resolution.

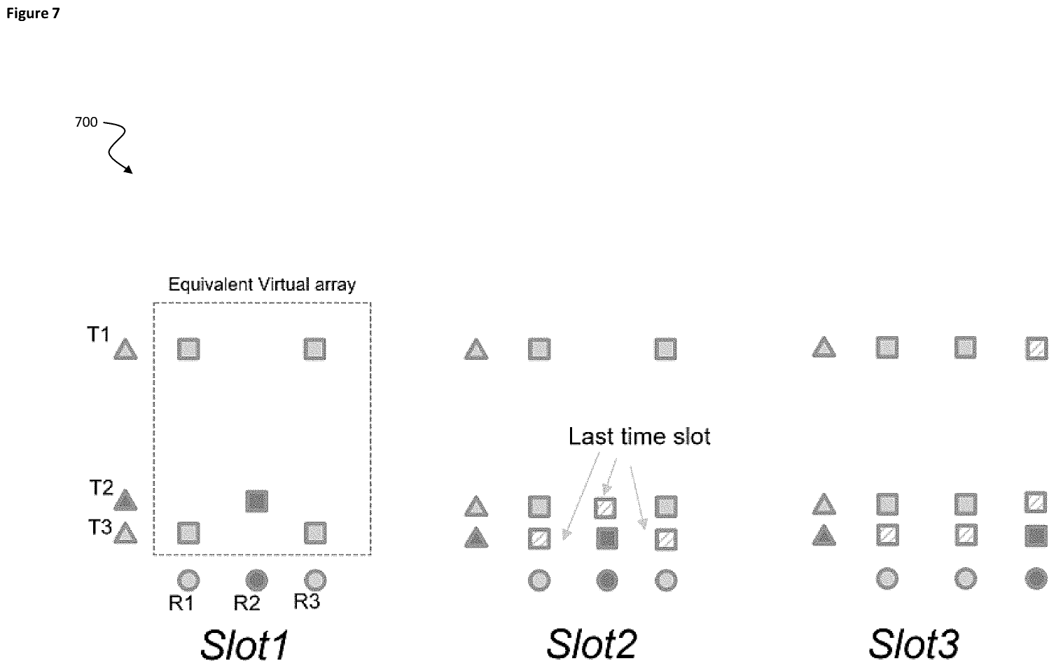

By applying the novel radar architecture according to this disclosure, T2 and T3 can choose different radar signals or chirps at each time slot to enhance orthogonality. This is shown in FIG. 7.

FIG. 7 shows a schematic diagram illustrating a virtual array example 700 for the radar system 400 shown in FIG. 4.

In the configuration of FIG. 7, antennas in closed proximity that for a potential coupling pair are provided with radar signals or chirps at different frequencies.

FIG. 7 shows the signals for three different time slots. Block shapes indicate that those antennas use another frequency chirp. Stripped shapes indicate array elements from previous slot.

It can be seen from FIG. 7 that over several time slots all possible virtual array positions have been covered. Thus, at all time slots potential coupling pairs can use different radar signals or chirps in order to provide maximum separation.

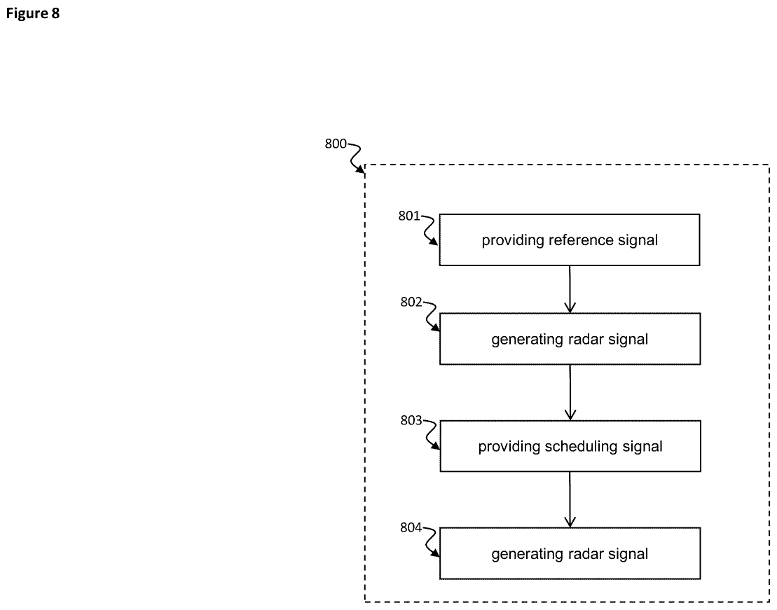

FIG. 8 shows a schematic diagram illustrating a method 800 for generating a plurality of radar signals according to the disclosure.

The method 800 comprises: providing 801 a reference signal 111 by a reference signal source 110, e.g., as described above with respect to FIG. 1.

The method 800 comprises: generating 802 a respective radar signal 123, 133, by a plurality of radar signal generators 120, 130, 140, based on the reference signal 111 for transmission via a millimeter-wave link 310, wherein a phase of the respective radar signal 123, 133 is aligned with a phase of the reference signal 111, e.g., as described above with respect to FIG. 1.

The method 800 comprises: providing 803, by a scheduler 150, for each of the plurality of radar signal generators 120, 130, 140 a respective scheduling signal 151, 152, 153, the scheduling signal 151, 152, 153 indicating a time-frequency characteristic 124, 134 for the respective radar signal 123, 133, e.g., as described above with respect to FIG. 1.

The method 800 comprises: generating 804, by each radar signal generator 120, 130, the respective radar signal 123, 133 having the time-frequency characteristic 124, 134 indicated by the respective scheduling signal 151, 152, e.g., as described above with respect to FIG. 1.

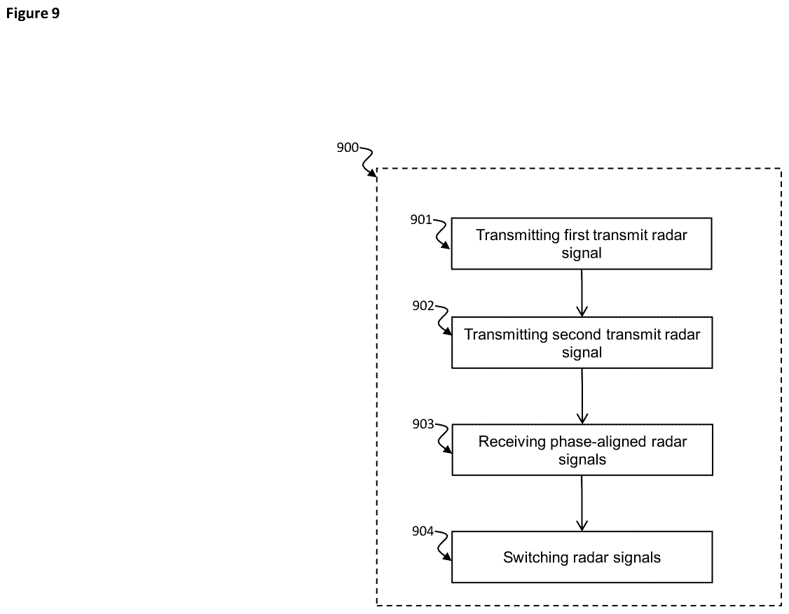

FIG. 9 shows a schematic diagram illustrating a method 900 for performing radar signal processing according to the disclosure.

The method 900 comprises: transmitting 901, by a first radar transceiver 220 of a plurality of radar transceivers, a first transmit radar signal 222 and/or receiving, by the first radar transceiver 220, a first receive radar signal 223, e.g., as described above with respect to FIG. 2.

The method 900 comprises: transmitting 902, by a second radar transceiver 230 of the plurality of radar transceivers, a second transmit radar signal 232 and/or receiving, by the second radar transceiver 230, a second receive radar signal 233, e.g., as described above with respect to FIG. 2.

The method 900 comprises: receiving 903, by a switch box 210, a plurality of phase-aligned radar signals 123, 133 via a millimeter-wave link 310, each radar signal 123, 133 having a corresponding time-frequency characteristic 124, 134, e.g., as described above with respect to FIG. 2.

The method 900 comprises: switching 904, by the switch box 210, based on a switching scheme, a first radar signal 123 of the plurality of phase-aligned radar signals 123, 133 to the first radar transceiver 220 for transmission as the first transmit radar signal 222 and switching, by the switch box 210, a second radar signal 133 of the plurality of phase-aligned radar signals 123, 133 to the second radar transceiver 230 for transmission as the second transmit radar signal 232, e.g., as described above with respect to FIG. 2.

While a particular feature or aspect of the present disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the present disclosure beyond those described herein. While the present disclosure has been described with reference to one or more particular embodiments, those skilled in the art recognize that many changes may be made thereto without departing from the scope of the present disclosure. It is therefore to be understood that the disclosure may be practiced otherwise than as specifically described herein.

What is claimed is:

1. A radar signal generator arrangement for generating a plurality of radar signals, the radar signal generator arrangement comprising:
a reference signal source configured to provide a reference signal;
a plurality of radar signal generators, each radar signal generator being configured to generate a respective radar signal based on the reference signal for transmission via a millimeter-wave link, wherein each radar signal generator is configured to align a phase of the respective radar signal with a phase of the reference signal; and
a scheduler configured to provide for each of the plurality of radar signal generators a respective scheduling signal, the scheduling signal indicating a time-frequency characteristic for the respective radar signal;
wherein each radar signal generator is further configured to generate the respective radar signal having the time-frequency characteristic indicated by the respective scheduling signal.

2. The radar signal generator arrangement of claim 1,
wherein each radar signal generator comprises a voltage-controlled oscillator or digital numerical controlled oscillator and a phase locked loop controller for controlling the oscillators;
wherein the scheduler is configured to provide each phase locked loop controller with a respective frequency control signal for controlling the oscillators to generate the radar signal having the time-frequency characteristic indicated by the respective scheduling signal.

3. The radar signal generator arrangement of claim 1,
wherein each radar signal comprises a respective millimeter wave chirp signal.

4. The radar signal generator arrangement of claim 1,
wherein the time-frequency characteristic is different for any two of the radar signals.

5. The radar signal generator arrangement of claim 1,
wherein the scheduler is configured to provide information about the time-frequency characteristic of the respective radar signals for transmission over the millimeter-wave link.

6. The radar signal generator arrangement of claim 1,
wherein the scheduler is configured to transmit configuration information and trigger information over the millimeter-wave link, the configuration information enabling a radar arrangement to perform radar topology configuration based on the radar signals provided by the radar signal generator arrangement, and wherein the radar topology configuration is enabled at certain timing based on the trigger information.

7. The radar signal generator arrangement of claim 1,
wherein a frequency of the reference signal is at least one order of magnitude smaller than a frequency of the respective radar signal.

8. A radar arrangement for performing radar signal processing, the radar arrangement comprising:
a first radar transceiver of a plurality of radar transceivers, the first radar transceiver being configured to transmit a first transmit radar signal and/or to receive a first receive radar signal;
a second radar transceiver of the plurality of radar transceivers, the second radar transceiver being configured to transmit a second transmit radar signal and/or to receive a second receive radar signal; and
a switch box configured to receive a plurality of phase-aligned radar signals via a millimeter-wave link, each radar signal having a corresponding time-frequency characteristic,
wherein the switch box is configured, based on a switching scheme, to switch a first radar signal of the plurality of phase-aligned radar signals to the first radar transceiver for transmission as the first transmit radar signal and to switch a second radar signal of the plurality of phase-aligned radar signals to the second radar transceiver for transmission as the second transmit radar signal.

9. The radar arrangement of claim 8,
wherein the switch box is configured to arbitrarily switch any of the phase-aligned radar signals to any of the plurality of radar transceivers.

10. The radar arrangement of claim 8,
wherein the time-frequency characteristic is different for any two of the radar signals.

11. The radar arrangement of claim 8,
configured to receive information about the time-frequency characteristic of the radar signals via the millimeter-wave link.

12. The radar arrangement of claim 8,
configured to receive configuration information via the millimeter-wave link, the configuration information enabling a configuration of the first radar transceiver and the second radar transceiver.

13. The radar arrangement of claim 8,
configured to transfer first echo data based on the first receive radar signal to a master processor; and/or
configured to transfer second echo data based on the second receive radar signal to the master processor.

14. The radar arrangement of claim 8,
configured to enable the first radar transceiver to receive the first receive radar signal that is based on a transmit radar signal from at least one other radar transceiver of the plurality of radar transceivers.

15. A radar system useable for automotive applications, the radar system comprising:
a radar signal generator arrangement of claim 1; and
at least one radar arrangement coupled to the radar signal generator arrangement via a millimeter-wave link.

16. The radar system of claim 15,
wherein the millimeter-wave link comprises a plurality of millimeter-wave links for transmission of the plurality of radar signals.

17. The radar system of claim 16,
wherein the plurality of millimeter-wave links comprises at least one of an optical link, a flexible waveguide, or a wireless link.

18. The radar system of claim 15,
configured to process one or more antenna beams, wherein each antenna beam is based on one or more transmit and/or receive radar signals of a plurality of radar transceivers of the at least one radar arrangement.

19. The radar system of claim 18,
configured to process multiple antenna beams simultaneously, wherein each antenna beam is based on at least one different transmit and/or receive radar signal.

20. The radar system of claim 18,
configured to adjust a beam width of an antenna beam by assigning specific transmit and/or receive radar signals of the plurality of radar transceivers to the antenna beam.

21. The radar system of claim 20,
configured to adjust a beam width of the antenna beam by assigning specific transmit and/or receive radar signals of radar transceivers which are located at different radar arrangements to the antenna beam.

22. A method for generating a plurality of radar signals, the method comprising:
providing a reference signal by a reference signal source;
generating a respective radar signal, by a plurality of radar signal generators, based on the reference signal for transmission via a millimeter-wave link, wherein a phase of the respective radar signal is aligned with a phase of the reference signal;
providing, by a scheduler, for each of the plurality of radar signal generators a respective scheduling signal, the scheduling signal indicating a time-frequency characteristic for the respective radar signal; and
generating, by each radar signal generator, the respective radar signal having the time-frequency characteristic indicated by the respective scheduling signal.

23. A method for performing radar signal processing, the method comprising:
transmitting, by a first radar transceiver of a plurality of radar transceivers, a first transmit radar signal and/or receiving, by the first radar transceiver, a first receive radar signal;
transmitting, by a second radar transceiver of the plurality of radar transceivers, a second transmit radar signal and/or receiving, by the second radar transceiver, a second receive radar signal;
receiving, by a switch box, a plurality of phase-aligned radar signals via a millimeter-wave link, each radar signal having a corresponding time-frequency characteristic; and
switching, by the switch box, based on a switching scheme, a first radar signal of the plurality of phase-aligned radar signals to the first radar transceiver for transmission as the first transmit radar signal and switching, by the switch box, a second radar signal of the plurality of phase-aligned radar signals to the second radar transceiver for transmission as the second transmit radar signal.
